(19) United States
(12) Patent Application Publication
(10) Pub. No.: US 2025/0316044 A1
(43) Pub. Date: Oct. 9, 2025

(54) METHOD OF PROCESSING VIRTUAL AVATAR, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Xiaodong ZHANG, Beijing (CN); Zhihuan ZHANG, Beijing (CN); Qian LIANG, Beijing (CN); Yichen LI, Beijing (CN)

(21) Appl. No.: 19/242,606

(22) Filed: Jun. 18, 2025

(30) Foreign Application Priority Data
Sep. 18, 2024 (CN) 202411304254.2

(51) Int. Cl. G06T 19/20; G06F 40/40

(52) U.S. Cl. CPC G06T 19/20; G06F 40/40; G06T 2200/24; G06T 2219/2024

(57) ABSTRACT

A method of processing a virtual avatar, an electronic device, and a storage medium are provided, which relate to a field of artificial intelligence technology, in particular to technical fields such as large models, virtual digital characters, virtual reality and augmented reality. The method includes: determining, according to an input text, at least one first prompt text and at least one first task to be executed corresponding to the at least one first prompt text, where the first task to be executed corresponds to at least one second task to be executed, and the second task to be executed corresponds to a second prompt text; and obtaining an initial virtual avatar according to at least one prompt text to be processed. The prompt text to be processed is obtained by fusing the first prompt text and at least one second prompt text corresponding to the first prompt text.

This application claims the benefit of priority to Chinese Patent Application No. 202411304254.2, filed on Sep. 18, 2024. The entire contents of this application are hereby incorporated herein by reference.

### TECHNICAL FIELD

The present disclosure relates to a field of artificial intelligence technology, in particular to technical fields such as large models, virtual digital characters, virtual reality and augmented reality, and may be applied to scenarios such as video games, computer graphics (CG) promotional videos, and digital character live-streaming. More specifically, the present disclosure provides a method of processing a virtual avatar, an electronic device, and a storage medium.

### BACKGROUND

With a development of artificial intelligence technology, application scenarios of large models are constantly increasing.

### SUMMARY

The present disclosure provides a method of processing a virtual avatar, a device, and a storage medium.

According to an aspect of the present disclosure, a method of processing a virtual avatar is provided, including: determining, according to an input text, at least one first prompt text and at least one first task to be executed corresponding to the at least one first prompt text, where the first task to be executed corresponds to at least one second task to be executed, and the second task to be executed corresponds to a second prompt text; and obtaining an initial virtual avatar according to at least one prompt text to be processed, where the prompt text to be processed is obtained by fusing the first prompt text and at least one second prompt text corresponding to the first prompt text.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the method provided in the present disclosure.

According to another aspect of the present disclosure, a non-transitory computer-readable storage medium having computer instructions therein is provided, and the computer instructions are configured to cause a computer to implement the method provided in the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure. This application contains at least one drawing executed in color. Copies of this patent application with color drawings will be provided by the Office upon request and payment of the necessary fee. In the accompanying drawings:

FIG. 1 shows a schematic diagram of an exemplary system architecture to which a method and an apparatus of processing a virtual avatar may be applied according to an embodiment of the present disclosure;

FIG. 2 shows a flowchart of a method of processing a virtual avatar according to an embodiment of the present disclosure;

FIG. 3 shows a schematic flowchart of determining a prompt text to be processed according to an embodiment of the present disclosure;

FIG. 4A shows a schematic diagram of a visual interface according to an embodiment of the present disclosure;

FIG. 4B shows a schematic diagram of an initial virtual avatar according to an embodiment of the present disclosure;

FIG. 5 shows a schematic diagram of adjusting a virtual avatar according to an embodiment of the present disclosure;

FIG. 6 shows a schematic diagram of an adjusted virtual avatar according to an embodiment of the present disclosure;

FIG. 7 shows a schematic partial diagram of an adjusted virtual avatar according to an embodiment of the present disclosure;

FIG. 8 shows a schematic block diagram of an apparatus of processing a virtual avatar according to an embodiment of the present disclosure; and

FIG. 9 shows a block diagram of an electronic device for implementing a method of processing a virtual avatar according to an embodiment of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

In application scenarios such as games, the digital human industry, and CG (Computer Graphics) animations, a production of virtual avatars requires professional designers to perform operations such as modeling and rigging in modeling software.

However, a production cost of a virtual avatar is very high. In order to produce an exquisite virtual character, a producer needs to have a solid foundation in character modeling and model rigging capabilities. Moreover, it is difficult for the producer to produce a virtual avatar that fully meets expectations in one go. After production, it takes a long time to make modifications. It requires a lot of time cost for a virtual avatar to meet production expectations. For related enterprises, it also requires a lot of manpower costs to produce an exquisite virtual avatar.

In addition, different producers have different evaluation criteria for virtual avatars. In a production process, a virtual avatar may be continuously modified to meet the evaluation criteria of most people. That is, in order to produce a virtual avatar, the producer needs to have rich production experience to reduce the number of modifications.

In addition, it is difficult for ordinary modelers, ordinary people, small and medium-sized teams and other personnel engaged in production of virtual avatars to quickly and efficiently obtain satisfactory virtual avatars. For enterprises or teams, it is difficult to resolve a contradiction between a required development cycle and an actual development cycle of a project. In application scenarios such as games, digital humans and CG animations, the technical development of virtual avatar production is limited.

In some embodiments, artificial intelligence technologies such as generative adversarial networks (GANs) and diffusion models may be used to enable a user to talk to a large model or upload an image to generate a three-dimensional virtual avatar head, so as to meet the desires of a producer with low requirements for portrait quality and with low art foundation. In other embodiments, it is also possible to generate a virtual avatar based on artificial intelligence technologies such as large language model (LLM), visual model, and three-dimensional image generation. For example, based on a text input by a user, it is possible to perform text analysis, visual mapping, two-dimensional face analysis, three-dimensional generation, and parametric representation.

However, an effect of a virtual avatar generated based on artificial intelligence technology depends largely on training data used to generate the virtual avatar. If the training data is not highly diverse or is biased, the generated virtual avatar may also have problems. In addition, generating a high-quality virtual avatar requires high hardware computing power. If the computing power of the user's hardware device is insufficient, it may lead to a slow generation speed and a poor effect of the virtual avatar. If the user is not familiar with three-dimensional modeling or artificial intelligence technology, it is also difficult to generate a virtual avatar using artificial intelligence technology. In addition, when generating a video, it is difficult to maintain a consistency of the virtual avatar in the video, resulting in a poor user experience.

In addition, based on artificial intelligence technology, it is possible to generate a three-dimensional virtual avatar based on a text or an image. However, in some cases, users may need more refined customized virtual avatars. When using artificial intelligence technology, users may need to upload their own images or provide personal information, which may lead to data privacy and security issues. In some scenarios, the generated virtual avatar may have a poor effect, and a matching degree between a generated result and a user input is not high, which requires further optimization and improvement.

Therefore, in order to efficiently generate a high-quality virtual avatar, the present disclosure provides a method of processing a virtual avatar. A system architecture of the method will be described below.

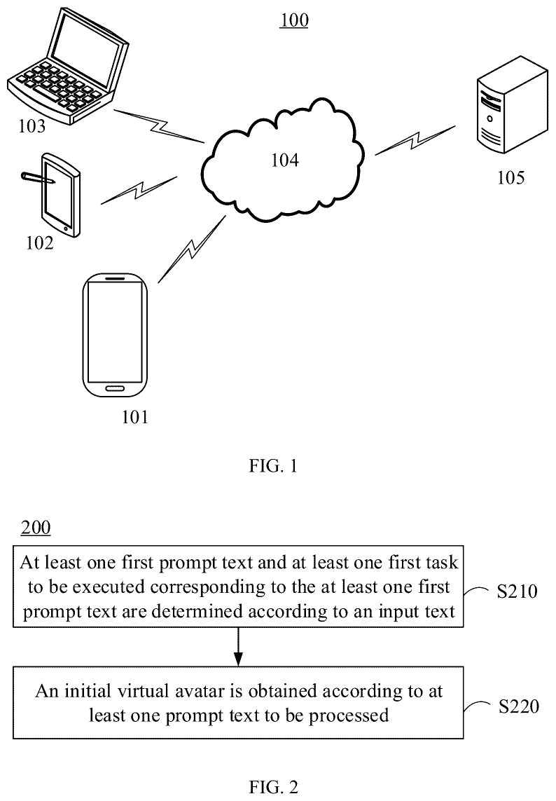

FIG. 1 shows a schematic diagram of an exemplary system architecture to which a method of processing a virtual avatar and an apparatus of processing a virtual avatar may be applied according to an embodiment of the present disclosure. It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios.

As shown in FIG. 1, a system architecture 100 according to such embodiments may include terminal devices 101, 102, 103, a network 104, and a server 105. The network 104 is a medium for providing a communication link between the terminal devices 101, 102, 103 and the server 105. The network 104 may include various connection types, such as wired and/or wireless communication links, etc.

The terminal devices 101, 102, 103 may be used by a user to interact with the server 105 through the network 104 to receive or send messages, etc. The terminal devices 101, 102, 103 may be various electronic devices with a display screen and supporting web browsing, including but not limited to smart phones, tablet computers, laptop portable computers, and desktop computers, etc.

The server 105 may be a server providing various services. For example, the server 105 may be a background management server (only for example) that provides support for websites browsed by the user using the terminal devices 101, 102, 103. The background management server may analyze and process received data such as a user request, and feed back a processing result (such as a web page, an information, or data acquired or generated according to the user request) to the terminal devices.

It should be noted that the method of processing the virtual avatar provided in embodiments of the present disclosure may generally be performed by the server 105. Accordingly, the apparatus of processing the virtual avatar provided in embodiments of the present disclosure may generally be disposed in the server 105. The method of processing the virtual avatar provided in embodiments of the present disclosure may also be performed by a server or a server cluster different from the server 105 and capable of communicating with the terminal devices 101, 102, 103 and/or the server 105. Accordingly, the apparatus of processing the virtual avatar provided in embodiments of the present disclosure may also be disposed in a server or a server cluster different from the server 105 and capable of communicating with the terminal devices 101, 102, 103 and/or the server 105.

It may be understood that the system architecture of the present disclosure has been described above. A description of the method of the present disclosure will be given below.

FIG. 2 shows a flowchart of a method of processing a virtual avatar according to an embodiment of the present disclosure.

As shown in FIG. 2, a method 200 may include operation S210 to operation S220.

In operation S210, at least one first prompt text and at least one first task to be executed corresponding to the at least one first prompt text are determined according to an input text.

In embodiments of the present disclosure, the input text may be a text input by a user. For example, the input text may be “I would like an appearance of a beauty blogger”.

In embodiments of the present disclosure, the first prompt text may be determined in various methods according to the input text. It is possible to segment the input text to obtain a plurality of word segments, and determine the first prompt text from the plurality of word segments. For example, a word segment with noun part of speech “beauty blogger” may be used as the first prompt text.

In embodiments of the present disclosure, the first prompt text may correspond to at least one first task to be executed. For example, the first prompt text “beauty blogger” may correspond to a face modification task, which may be used as a first task to be executed. It may be understood that a corresponding relationship between the prompt text and the task to be executed may be predetermined.

In embodiments of the present disclosure, the first task to be executed corresponds to at least one second task to be executed. For example, the face modification task may correspond to an eye modification task, a nose modification task, a lip modification task and an ear modification task. Each of the eye modification task, the nose modification task, the lip modification task and the ear modification task may be used as one second task to be executed.

In embodiments of the present disclosure, the second task to be executed may correspond to a second prompt text. For example, the second prompt text may be determined from the input text, or may be predetermined. When the input text is “I would like an appearance of a beauty blogger” and the second task to be executed is the eye modification task, the second prompt text may be a predetermined “double-eyelid”.

In operation S220, an initial virtual avatar is obtained according to at least one prompt text to be processed.

In embodiments of the present disclosure, the prompt text to be processed is obtained by fusing the first prompt text and at least one second prompt text corresponding to the first prompt text. For example, the first prompt text “beauty blogger” corresponds to the face modification task, the face modification task corresponds to the eye modification task, the eye modification task corresponds to the second prompt text “double-eyelid”, and the second prompt text “double-eyelid” corresponds to the first prompt text “beauty blogger”. The first prompt text and the second prompt text may be concatenated to serve as the prompt text to be processed.

In embodiments of the present disclosure, one or more materials may be determined according to the prompt text to be processed. For example, it is possible to determine materials corresponding to “beauty blogger” and “double-eyelid”. The virtual avatar may be obtained according to these materials.

Through embodiments of the present disclosure, the first prompt text and the first task to be executed may be determined according to the input text of the user, and the second task to be executed corresponding to the first task to be executed may be determined, so that an exquisite virtual avatar may be generated efficiently. The requirements for user input may be reduced, and the user only needs to input a simple natural language text to generate a high-quality virtual avatar that meets a text description, which may effectively improve the user experience and lower a threshold for generating a virtual avatar.

It may be understood that the method of the present disclosure has been described above. A description of the prompt text of the present disclosure will be given below.

In some embodiments, in some implementations of the above operation S210, a large model may be used to determine at least one first prompt text and at least one first task to be executed according to the input text. The large model may be a large language model (LLM). The large language model may be various conversational artificial intelligence models such as ERNIE Bot.

In some embodiments, the large model may be obtained by fine-tuning using a plurality of sample texts and a plurality of predetermined prompt texts. The first prompt text may be determined from the plurality of predetermined prompt texts by using the large model. The sample texts may be historical texts input by a user into the large model, or historical texts input by multiple users with similar attributes into the large model, or texts with high similarity generated according to historical texts input by users, which are not limited in the present disclosure. The large model may be a conversational large model such as ERNIE Bot. Through embodiments of the present disclosure, by using a conversational large model, it is possible to use a short natural-language text prompt to quickly generate a virtual avatar based on produced materials in a material production platform. The large model is obtained by fine-tuning using predetermined prompt texts, and the predetermined prompt texts may correspond to identification texts of the materials, so that the fine-tuned large model may quickly determine a material corresponding to the first prompt text from a plurality of materials.

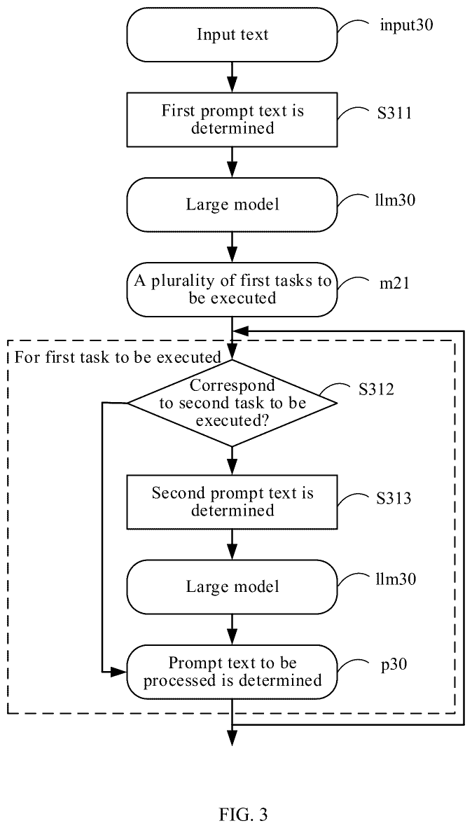

FIG. 3 shows a schematic flowchart of determining a prompt text to be processed according to an embodiment of the present disclosure.

As shown in FIG. 3, an operation S311 may be performed according to an input text input20 entered by the user,.

In operation S311, a first prompt text is determined. For example, the input text input30 may be “I would like an appearance of a beauty blogger, with long red hair, trendy makeup and stylish clothing”. According to the input text input30, a plurality of first prompt texts may be determined, including “beauty blogger”, “long red hair”, “trendy makeup”, and “stylish clothing”.

As shown in FIG. 3, a first task to be executed corresponding to the first prompt text may then be determined from a plurality of predetermined tasks by using the large model llm30. For example, the plurality of predetermined tasks may include a face modification task, a hairstyle modification task, a makeup modification task, a clothing matching task, and an accessory matching task, etc. According to the plurality of first prompt texts, it may be determined that a plurality of first tasks to be executed include a face modification task, a hairstyle modification task, a makeup modification task, and a clothing matching task.

It is also possible to determine a corresponding relationship between the first prompt text and the first task to be executed by using the large model llm30. For example, a plurality of corresponding relationships may include “face modification: beauty blogger”, “hairstyle modification: long red hair”, “makeup modification: trendy makeup”, “clothing matching: stylish clothing”. Then, for the first task to be executed, a task to be processed corresponding to the first task to be executed may be determined.

In operation S312, it is determined whether the first task to be executed corresponds to a second task to be executed.

For example, taking the face modification task as an example, the face modification task may correspond to a face-style determination task, an eye adjustment task, a nose adjustment task, a mouth adjustment task, an eyebrow adjustment task and an ear adjustment task, which may be used as a plurality of second tasks to be executed. It may be determined that the face modification task corresponds to a plurality of second tasks to be executed.

In operation S313, a second prompt text is determined.

For example, the face-style determination task, the eye adjustment task, the nose adjustment task, the mouth adjustment task, the eyebrow adjustment task and the ear adjustment task may correspond to respective predetermined prompt texts, which may be referred to as default prompt texts. The plurality of predetermined prompt texts corresponding to the plurality of second tasks to be executed may be used as a plurality of second prompt texts. The predetermined prompt text corresponding to the eye adjustment task may be “double-eyelid”.

As shown in FIG. 3, a prompt text to be processed p30 may be determined using the large model llm30. For example, the plurality of second prompt texts may be concatenated with the first prompt text. In the concatenation process, the second prompt text “double-eyelid” corresponding to the eye adjustment task may be concatenated with the first prompt text “beauty blogger” corresponding to the face modification task.

Then, the above operation S312 and operation S313 may be repeatedly performed for one or more tasks other than the face modification task among the plurality of first tasks to be executed, so as to obtain a plurality of prompt texts to be processed corresponding to the plurality of first tasks to be executed.

It may be understood that the first task to be executed and the second task to be executed have been described above with reference to the face modification task. However, the present disclosure is not limited thereto, and each of the hairstyle modification task, the makeup modification task, the clothing matching task and the accessory matching task also corresponds to one or more tasks. For example, the hairstyle modification task corresponds to a hair-size determination task, a hair-color determination task, etc. The makeup modification task may correspond to a face-makeup determination task, an eye-makeup determination task, a lip-makeup determination task, etc. The clothing matching task may correspond to a clothing determination task, a pattern determination task, etc. The accessory matching task may correspond to an earring determination task, a glasses determination task, a necklace determination task, a ring determination task, a headwear determination task, etc. Through embodiments of the present disclosure, not only material attributes of the virtual avatar but also hairstyle and clothing that meet the requirements may be determined quickly according to the input text.

It may be understood that the method of determining the prompt text to be processed has been described above. A description of some methods of obtaining the initial virtual avatar will be given below.

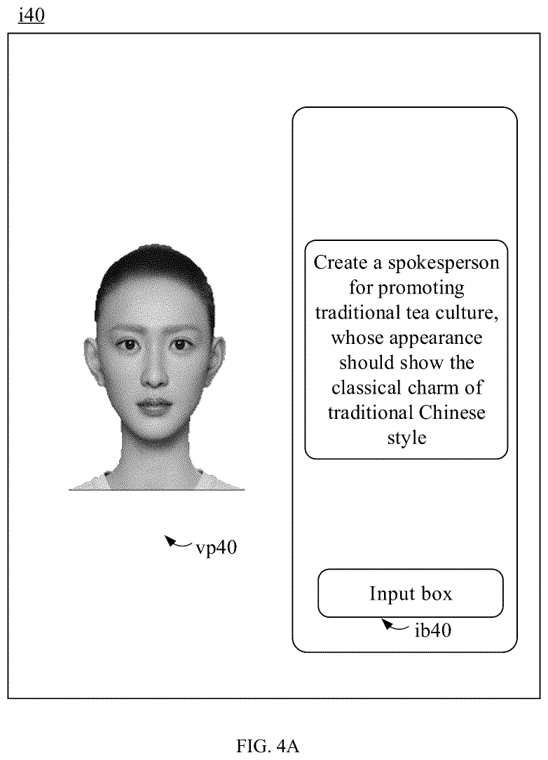

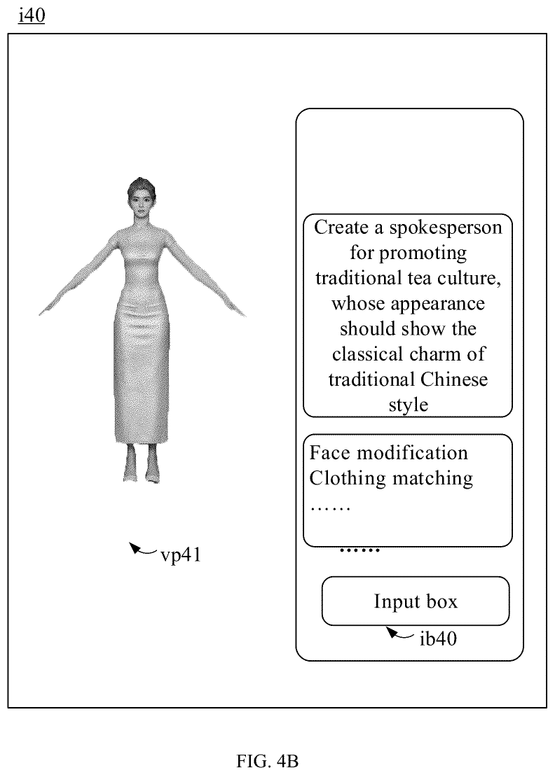

FIG. 4A shows a schematic diagram of a visual interface according to an embodiment of the present disclosure.

As shown in FIG. 4A, a visual interface i40 may include an input box ib40, and the visual interface i40 may also present a predetermined virtual avatar vp40.

The user is allowed to use the input box ib40 to input a text “Create a spokesperson for promoting traditional tea culture, whose appearance should show the classical charm of traditional Chinese style”. Then, a plurality of prompt texts to be processed may be determined to generate an initial virtual avatar, which will be described below.

In some embodiments, in some implementations of the above operation S220, obtaining the initial virtual avatar according to at least one prompt text to be processed includes: determining at least one task to be processed according to the at least one prompt text to be processed. The task to be processed may correspond to the first task to be executed and at least one second task to be executed. For example, taking the clothing matching task as an example, a task to be processed may correspond to the clothing matching task, the clothing determination task, and the pattern determination task. The clothing matching task may be used as the first task to be executed, and the clothing determination task and the pattern determination task may be used as the second tasks to be executed. It may be understood that the prompt text to be processed corresponding to the task to be processed may be obtained by concatenating the first prompt text “traditional Chinese style” and the second prompt text “cheongsam”.

In embodiments of the present disclosure, an identification text of the task to be processed may be presented on the visual interface. As shown in FIG. 4A, the identification texts of the tasks to be processed, such as “face modification” and “clothing matching”, may be presented on the visual interface. It may be understood that the identification text of the task to be processed may be an identification text of the corresponding first task to be executed.

In embodiments of the present disclosure, determining at least one task to be processed according to at least one prompt text to be processed includes: determining at least one material to be processed and at least one target attribute information corresponding to the at least one material to be processed according to the at least one prompt text to be processed; and determining the at least one task to be processed according to the at least one material to be processed and the at least one target attribute information corresponding to the at least one material to be processed. For example, according to the “cheongsam” in the prompt text to be processed, a cheongsam material may be determined as the material to be processed from a plurality of clothing materials. Attributes of a clothing material may include identification, color, texture, etc. The identification corresponds to a clothing material, and when a plurality of identifications are changed, the clothing material may also be replaced. A task to be processed may be determined according to the cheongsam material and a default attribute information of the cheongsam material. The task to be processed may be provided to a rendering engine.

It may be understood that the materials of the present disclosure have been described above by taking the clothing material as an example. However, the present disclosure is not limited thereto, and the plurality of materials may further include a portrait material, a hair material, and an accessory material, etc. The attributes of the materials may include identification, color, texture, etc., and the attributes of the materials may be adjusted.

In some embodiments, in some implementations of the above operation S220, obtaining the initial virtual avatar according to at least one prompt text to be processed further includes: processing at least one task to be processed to obtain the initial virtual avatar. For example, the rendering engine may be used to process at least one task to be processed to obtain the initial virtual avatar. It may be understood that the task to be processed may indicate one or more materials, or indicate the attributes of one or more materials. The rendering engine may render the materials according to the relevant attributes, so as to obtain the initial virtual avatar. This will be described below with reference to FIG. 4B.

FIG. 4B shows a schematic diagram of an initial virtual avatar according to an embodiment of the present disclosure.

As shown in FIG. 4B, an initial virtual avatar vp41 may be presented on the visual interface i40, and the clothing of the initial virtual avatar vp41 may be a cheongsam.

It may be understood that some methods of obtaining the virtual avatar of the present disclosure have been described above. A description of some methods of adjusting the virtual avatar will be given below.

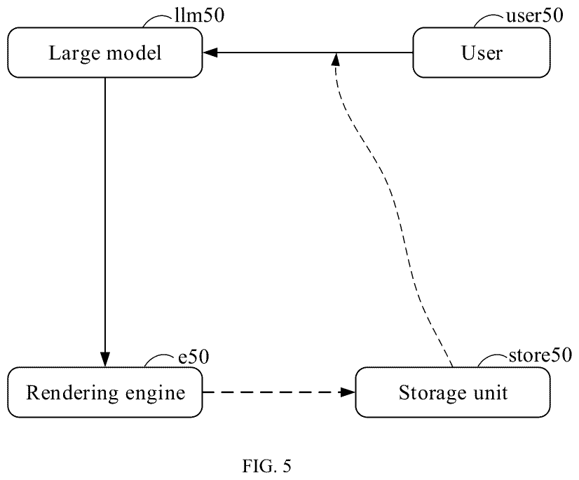

In some embodiments, an adjusted virtual avatar is obtained according to an adjustment text and the initial virtual avatar, which will be described below with reference to FIG. 5.

FIG. 5 shows a schematic diagram of adjusting a virtual avatar according to an embodiment of the present disclosure.

As shown in FIG. 5, a text may be input by a user user50. A large model llm50 may receive the text and determine one or more tasks according to the text. A rendering engine e50 may execute the one or more tasks. One or more first prompt texts, second prompt texts, prompt texts to be processed, and one or more materials to be processed corresponding to the prompt texts to be processed used by the large model llm50 may be stored as historical data in a storage unit store50.

In embodiments of the present disclosure, obtaining the adjusted virtual avatar according to the adjustment text and the initial virtual avatar may include: obtaining the adjusted virtual avatar after one or more adjustment rounds according to the adjustment text for the one or more adjustment rounds and the initial virtual avatar. An adjustment in an initial adjustment round will be described below.

In embodiments of the present disclosure, obtaining the adjusted virtual avatar according to the adjustment text and the initial virtual avatar includes: determining at least one adjustment prompt text and at least one attribute adjustment information according to the adjustment text. The at least one adjustment prompt text and the at least one attribute adjustment information may be determined by using a large model according to the adjustment text for an initial adjustment round. The large model may be the above-mentioned large model llm30. The adjustment prompt text may be determined from a plurality of predetermined prompt texts. For example, for the initial virtual avatar vp41, in the initial adjustment round, the adjustment text input by the user may include “Change the color of hair, lighten the color of clothing, and deepen the color of lipstick”. Thus, the adjustment prompt texts “hair”, “clothing” and “lipstick” for the initial adjustment round may be determined. The attribute adjustment information corresponding to the adjustment prompt text “hair” may be changing the color, the attribute adjustment information corresponding to the adjustment prompt text “clothing” may be lightening the color, and the attribute adjustment information corresponding to the adjustment prompt text “lipstick” may be deepening the color.

In embodiments of the present disclosure, obtaining the adjusted virtual avatar according to the adjustment text and the initial virtual avatar may further include: in response to determining that the adjustment prompt text hits a historical prompt text, determining a material adjustment task according to at least one material to be adjusted corresponding to the hit historical prompt text and the attribute adjustment information corresponding to the adjustment prompt text. The historical prompt text is obtained according to at least one of the prompt text to be processed, the first prompt text, or the second prompt text. For example, the historical prompt texts stored in the storage unit store50 may include the first prompt text “traditional Chinese style” and the second prompt text “cheongsam”, and the adjustment prompt text “clothing” may hit the second prompt text “cheongsam”. The large model llm50 may determine a material adjustment task by using the attribute adjustment information of lightening the color and the cheongsam material corresponding to the second prompt text “cheongsam”. The material adjustment task may be provided to the rendering engine e50.

In embodiments of the present disclosure, obtaining the adjusted virtual avatar according to the adjustment text and the initial virtual avatar may further include: obtaining the adjusted virtual avatar according to the initial virtual avatar and the material adjustment task. For example, for the initial virtual avatar vp41, the rendering engine e50 may execute the material adjustment task to lighten the color of the cheongsam material for the initial virtual avatar vp41 to obtain an adjusted material. It may be understood that it is also possible to determine, based on the adjustment prompt text “hair” and the adjustment prompt text “lipstick”, the corresponding materials to be adjusted from the plurality of materials used to generate the initial virtual avatar vp41. Two tasks may be determined respectively by using the attribute adjustment information “change the color” and the attribute adjustment information “deepen the color”. After these two tasks are executed by the rendering engine, the adjusted materials may be obtained. The adjusted virtual avatar of the initial adjustment round may be obtained based on these adjusted materials.

Through embodiments of the present disclosure, when adjusting the virtual avatar, historical prompt texts and corresponding materials are used, and the materials to be adjusted may be quickly determined from the historically used materials to reduce the hardware resources required to adjust the virtual avatar. In a case of determining tasks using a large model, the number of tokens may be reduced, and a response speed of the large model may be increased, which may help improve the user experience.

Through embodiments of the present disclosure, various materials used to generate the virtual avatar may be fine-tuned, and various attributes (such as texture, color) of the virtual avatar may be adjusted quickly and in real time according to the text input by the user, so as to achieve changes in face makeup, eye makeup and lip makeup effects of the virtual avatar. It is also possible to adjust attributes such as color and glossiness of hair, or adjust attributes such as color and texture of clothing or color and size of logo on clothing, or adjust attributes such as transparency, color and texture of accessories (such as glasses).

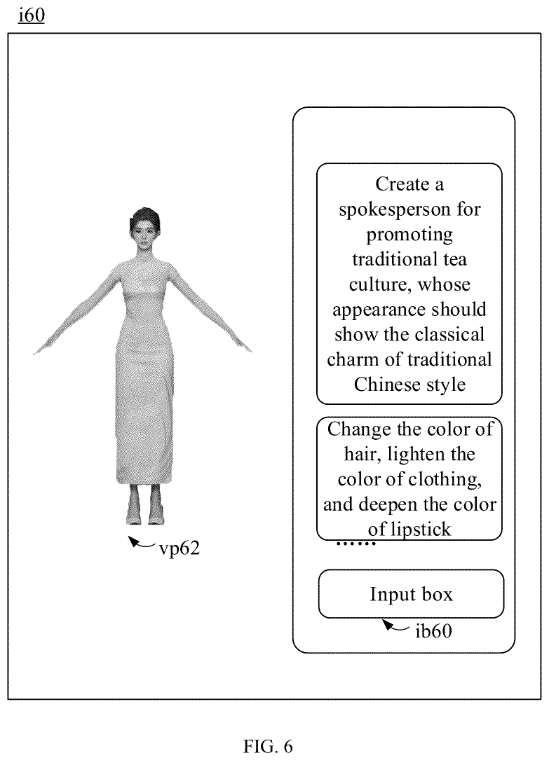

In embodiments of the present disclosure, obtaining the adjusted virtual avatar according to the adjustment text and the initial virtual avatar may further include: presenting the adjusted virtual avatar on a visual interface. A further description will be given below with reference to FIG. 6.

FIG. 6 shows a schematic diagram of an adjusted virtual avatar according to an embodiment of the present disclosure.

As shown in FIG. 6, an adjusted virtual avatar vp62 may be presented on a visual interface i60. The adjusted virtual avatar vp62 may be obtained by adjusting the initial virtual avatar vp41. Thus, the adjustment of the initial adjustment round is completed.

Then, according to the user input, it is possible to perform an adjustment of a next adjustment round, or end the flow and store the adjusted virtual avatar. The present disclosure will be further described below by taking a case of a plurality of adjustment rounds as an example.

In embodiments of the present disclosure, obtaining the adjusted virtual avatar after one or more adjustment rounds according to the adjustment text for the one or more adjustment rounds and the initial virtual avatar includes: obtaining the adjusted virtual avatar of a target adjustment round among a plurality of adjustment rounds according to the adjustment text for the target adjustment round and the adjusted virtual avatar of a previous adjustment round of the target adjustment round. For example, after the adjusted virtual avatar vp62 is presented, a text “The hair color doesn't look good, please return to the previous version” may be input by the user. Thus, the adjustment may enter a second adjustment round, that is, a round after the initial adjustment round. The text “The hair color doesn't look good, please return to the previous version” may be used as the adjustment text for the second adjustment round. According to the adjustment text, the adjustment prompt text “hair” and the corresponding attribute adjustment information “return to the previous version” may be determined.

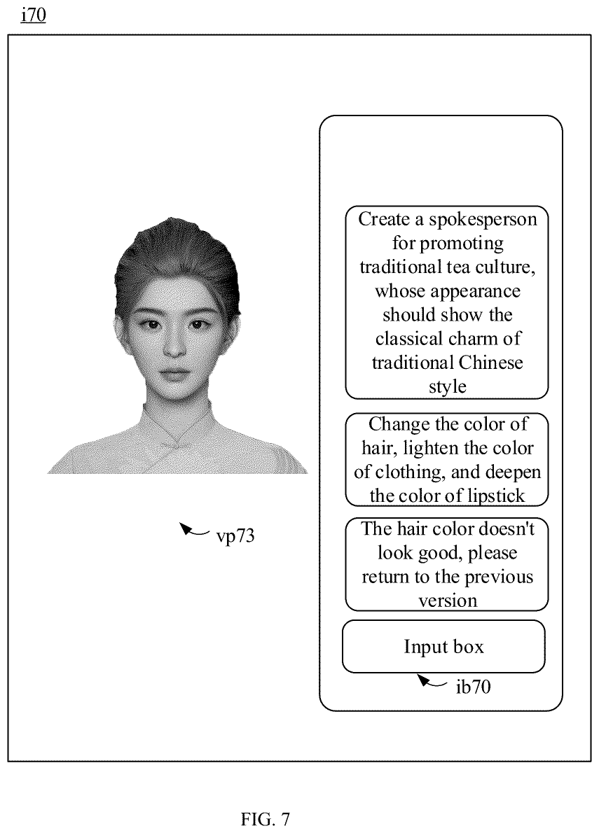

In embodiments of the present disclosure, the historical prompt text for the target adjustment round is obtained according to at least one of the prompt text to be processed, the first prompt text, the second prompt text, or the adjustment prompt text for at least one previous adjustment round. For example, in the historical data stored in the storage unit store50, the adjustment prompt texts “hair”, “clothing” and “lipstick” for the initial adjustment round may be stored in the storage unit store50 as historical prompt texts. In the second adjustment round, the adjustment prompt text “hair” may hit the historical prompt text “hair”. A material adjustment task may be determined by using the attribute adjustment information “return to the previous version” and the material corresponding to the historical prompt text “hair”. The rendering engine may execute the task and adjust the adjusted virtual avatar of the initial adjustment round to obtain the adjusted virtual avatar of the second adjustment round as the adjusted virtual avatar of the target adjustment round. The adjusted virtual avatar may then be presented, which will be described below with reference to FIG. 7.

FIG. 7 shows a schematic partial diagram of an adjusted virtual avatar according to an embodiment of the present disclosure.

As shown in FIG. 7, a scaling factor of a visual interface i70 may be adjusted to present a head of an adjusted virtual avatar vp73. As shown in FIG. 7, the hair color of the adjusted virtual avatar vp73 is consistent with that of the initial virtual avatar vp41. Through embodiments of the present disclosure, the user is allowed to modify the hairstyle, makeup, clothing, accessories and other materials of the virtual avatar by using natural language, and the materials used to generate the virtual avatar may be stored, thereby supporting a historical backtracking function such as returning to the previous version or the original version.

In some embodiments, the method may further include: fusing the virtual avatar with motion-driven data. For example, the adjusted virtual avatar may be fused with the motion-driven data of a predetermined expression to drive a facial expression present.

In some embodiments, the method may further include: storing a file corresponding to the virtual avatar. For example, the file may be in various formats. Through embodiments of the present disclosure, the initial virtual avatar and the adjusted virtual avatar of any adjustment round may be saved as files in required formats, which may be modified by other users and may be compatible with most rendering engines.

It may be understood that the method of the present disclosure has been described above. A further description of the application scenarios of the present disclosure will be given below.

In some embodiments, in a video game scenario, based on the above method, a plurality of virtual characters that meet the requirements may be produced quickly and simultaneously by the user by inputting natural language texts, and a virtual avatar that meets the requirements may be selected from the plurality of avatars for further adjustment and production. It only takes a few minutes to generate a virtual avatar, so that the production time length of virtual avatar may be greatly reduced, and the development efficiency may be significantly improved. In the development process, if the appearance, clothing, makeup, hairstyle, accessories, etc. of the virtual avatar need to be modified, it is possible to import the corresponding files into the rendering engine and input the adjustment text, so as to quickly modify the virtual avatar by using the method of the present disclosure. The virtual avatar may be modified only through dialogues, even without requiring professional designers or any art foundation or professional knowledge.

In some embodiments, in various styles of CG animations, promotional videos, or virtual character green-screen scenarios, based on the method provided by the present disclosure, it is possible to quickly generate a virtual avatar matched with a text by inputting a natural language text.

In some embodiments, in various virtual digital character live-streaming scenarios, based on the method provided by the present disclosure, it is possible to quickly produce a plurality of virtual digital characters in batches by inputting a natural language text, and establish a virtual digital character library according to generation results. Then, various styles of digital characters may be replaced in the scenarios to meet different shooting or live-streaming requirements, thereby achieving a rapid completion of various virtual digital character projects.

It may be understood that the method of the present disclosure has been described above. A description of an apparatus of the present disclosure will be given below.

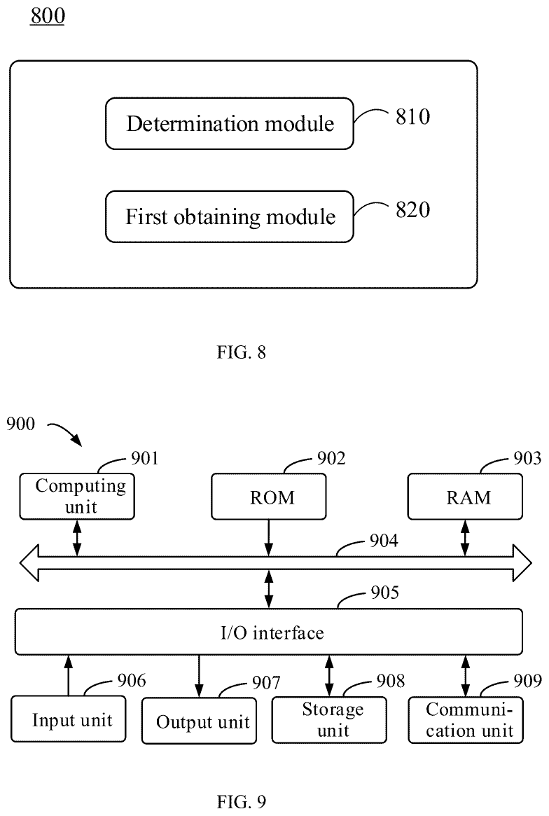

FIG. 8 shows a schematic block diagram of an apparatus of processing a virtual avatar according to an embodiment of the present disclosure.

As shown in FIG. 8, an apparatus 800 may include a determination module 810 and a first obtaining module 820.

The determination module 810 is used to determine, according to an input text, at least one first prompt text and at least one first task to be executed corresponding to the at least one first prompt text. The first task to be executed corresponds to at least one second task to be executed, and the second task to be executed corresponds to a second prompt text.

The first obtaining module 820 is used to obtain an initial virtual avatar according to at least one prompt text to be processed. The prompt text to be processed is obtained by fusing the first prompt text and at least one second prompt text corresponding to the first prompt text.

In some embodiments, the first obtaining module includes: a first determination sub-module used to determine at least one task to be processed according to the at least one prompt text to be processed, where the task to be processed corresponds to the first task to be executed and the at least one second task to be executed; and a processing sub-module used to process the at least one task to be processed to obtain the initial virtual avatar.

In some embodiments, the first determination sub-module includes: a first determination unit used to determine at least one material to be processed and at least one target attribute information corresponding to the at least one material to be processed according to the at least one prompt text to be processed; and a second determination unit used to determine the at least one task to be processed according to the at least one material to be processed and the at least one target attribute information corresponding to the at least one material to be processed.

In some embodiments, the apparatus 800 further includes: a second obtaining module used to obtain an adjusted virtual avatar according to an adjustment text and the initial virtual avatar.

In some embodiments, the second obtaining module includes: a second determination sub-module used to determine at least one adjustment prompt text and at least one attribute adjustment information according to the adjustment text; a third determination sub-module used to determine, in response to determining that the adjustment prompt text hits a historical prompt text, a material adjustment task according to at least one material to be adjusted corresponding to the hit historical prompt text and the attribute adjustment information corresponding to the adjustment prompt text, where the historical prompt text is obtained according to at least one of the prompt text to be processed, the first prompt text, or the second prompt text; and a first obtaining sub-module used to obtain the adjusted virtual avatar according to the initial virtual avatar and the material adjustment task.

In some embodiments, the second obtaining module includes: a second obtaining sub-module used to obtain the adjusted virtual avatar after one or more adjustment rounds according to the adjustment text for the one or more adjustment rounds and the initial virtual avatar.

In some embodiments, the one or more adjustment rounds include a plurality of adjustment rounds, and the second obtaining sub-module includes: a first obtaining unit used to obtain the adjusted virtual avatar of a target adjustment round among the plurality of adjustment rounds according to the adjustment text for the target adjustment round and the adjusted virtual avatar of a previous adjustment round of the target adjustment round.

In some embodiments, the second obtaining sub-module includes: a second obtaining unit used to obtain the adjusted virtual avatar of an initial adjustment round among the plurality of adjustment rounds according to the initial virtual avatar and the adjustment text for the initial adjustment round.

In some embodiments, a historical prompt text for the target adjustment round is obtained according to at least one of the prompt text to be processed, the first prompt text, the second prompt text, or the adjustment prompt text for at least one previous adjustment round.

In some embodiments, the determination module includes: a fourth determination sub-module used to determine, by using a large model, the at least one first prompt text and the at least one first task to be executed according to the input text.

In some embodiments, the second determination sub-module includes: a third determination unit used to determine, by using a large model, the at least one adjustment prompt text and the at least one attribute adjustment information according to the adjustment text.

In some embodiments, the large model is obtained by fine-tuning using a plurality of sample texts and a plurality of predetermined prompt texts, and the first prompt text and the adjustment prompt text are determined from the plurality of predetermined prompt texts by using the large model.

In some embodiments, the first obtaining module includes: a present sub-module used to present the initial virtual avatar on a visual interface.

In some embodiments, the processing sub-module includes: a present unit used to present an identification text of the task to be processed on a visual interface.

In technical solutions of the present disclosure, a collection, a storage, a use, a processing, a transmission, a provision, a disclosure and other processing of user personal information involved all comply with provisions of relevant laws and regulations and do not violate public order and good customs.

According to embodiments of the present disclosure, the present disclosure further provides an electronic device, a readable storage medium, and a computer program product.

FIG. 9 schematically shows a schematic block diagram of an exemplary electronic device 900 that may be used to implement embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 9, the electronic device 900 includes a computing unit 901 which may perform various appropriate actions and processes according to a computer program stored in a read only memory (ROM) 902 or a computer program loaded from a storage unit 908 into a random access memory (RAM) 903. In the RAM 903, various programs and data necessary for an operation of the electronic device 900 may also be stored. The computing unit 901, the ROM 902 and the RAM 903 are connected to each other through a bus 904. An input/output (I/O) interface 905 is also connected to the bus 904.

A plurality of components in the electronic device 900 are connected to the I/O interface 905, including: an input unit 906, such as a keyboard, or a mouse; an output unit 907, such as displays or speakers of various types; a storage unit 908, such as a disk, or an optical disc; and a communication unit 909, such as a network card, a modem, or a wireless communication transceiver. The communication unit 909 allows the electronic device 900 to exchange information/data with other devices through a computer network such as Internet and/or various telecommunication networks.

The computing unit 901 may be various general-purpose and/or dedicated processing assemblies having processing and computing capabilities. Some examples of the computing units 901 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 901 executes various methods and processes described above, such as the method of processing the virtual avatar. For example, in some embodiments, the method of processing the virtual avatar may be implemented as a computer software program which is tangibly embodied in a machine-readable medium, such as the storage unit 908. In some embodiments, the computer program may be partially or entirely loaded and/or installed in the electronic device 900 via the ROM 902 and/or the communication unit 909. The computer program, when loaded in the RAM 903 and executed by the computing unit 901, may execute one or more steps in the method of processing the virtual avatar described above. Alternatively, in other embodiments, the computing unit 901 may be used to perform the method of processing the virtual avatar by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the method of processing the virtual avatar of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and typically interact through a communication network. A relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of processing a virtual avatar, comprising:
determining, according to an input text, at least one first prompt text and at least one first task to be executed corresponding to the at least one first prompt text, wherein the first task to be executed corresponds to at least one second task to be executed, and the second task to be executed corresponds to a second prompt text; and
obtaining an initial virtual avatar according to at least one prompt text to be processed, wherein the prompt text to be processed is obtained by fusing the first prompt text and at least one second prompt text corresponding to the first prompt text.

2. The method according to claim 1, wherein the obtaining an initial virtual avatar according to at least one prompt text to be processed comprises:
determining at least one task to be processed according to the at least one prompt text to be processed, wherein the task to be processed corresponds to the first task to be executed and the at least one second task to be executed; and
processing the at least one task to be processed to obtain the initial virtual avatar.

3. The method according to claim 2, wherein the determining at least one task to be processed according to the at least one prompt text to be processed comprises:
determining at least one material to be processed and at least one target attribute information corresponding to the at least one material to be processed according to the at least one prompt text to be processed; and
determining the at least one task to be processed according to the at least one material to be processed and the at least one target attribute information corresponding to the at least one material to be processed.

4. The method according to claim 1, further comprising:
obtaining an adjusted virtual avatar according to an adjustment text and the initial virtual avatar.

5. The method according to claim 4, wherein the obtaining an adjusted virtual avatar according to an adjustment text and the initial virtual avatar comprises:
determining at least one adjustment prompt text and at least one attribute adjustment information according to the adjustment text;
determining, in response to determining that the adjustment prompt text hits a historical prompt text, a material adjustment task according to at least one material to be adjusted corresponding to the hit historical prompt text and the attribute adjustment information corresponding to the adjustment prompt text, wherein the historical prompt text is obtained according to at least one of the prompt text to be processed, the first prompt text, or the second prompt text; and
obtaining the adjusted virtual avatar according to the initial virtual avatar and the material adjustment task.

6. The method according to claim 4, wherein the obtaining an adjusted virtual avatar according to an adjustment text and the initial virtual avatar comprises:
obtaining the adjusted virtual avatar after one or more adjustment rounds according to the adjustment text for the one or more adjustment rounds and the initial virtual avatar.

7. The method according to claim 6, wherein the one or more adjustment rounds comprise a plurality of adjustment rounds, and the obtaining the adjusted virtual avatar after one or more adjustment rounds according to the adjustment text for the one or more adjustment rounds and the initial virtual avatar comprises:
obtaining the adjusted virtual avatar of a target adjustment round among the plurality of adjustment rounds according to the adjustment text for the target adjustment round and the adjusted virtual avatar of a previous adjustment round of the target adjustment round.

8. The method according to claim 6, wherein the one or more adjustment rounds comprise a plurality of adjustment rounds, and the obtaining the adjusted virtual avatar after one or more adjustment rounds according to the adjustment text for the one or more adjustment rounds and the initial virtual avatar comprises:
obtaining the adjusted virtual avatar of an initial adjustment round among the plurality of adjustment rounds according to the initial virtual avatar and the adjustment text for the initial adjustment round.

9. The method according to claim 7, wherein a historical prompt text for the target adjustment round is obtained according to at least one of the prompt text to be processed, the first prompt text, the second prompt text, or the adjustment prompt text for at least one previous adjustment round of the target adjustment round.

10. The method according to claim 1, wherein the determining, according to an input text, at least one first prompt text and at least one first task to be executed corresponding to the at least one first prompt text comprises:
determining, by using a large model, the at least one first prompt text and the at least one first task to be executed according to the input text.

11. The method according to claim 5, wherein the determining at least one adjustment prompt text and at least one attribute adjustment information according to the adjustment text comprises:
determining, by using a large model, the at least one adjustment prompt text and the at least one attribute adjustment information according to the adjustment text.

12. The method according to claim 5, wherein the determining, according to an input text, at least one first prompt text and at least one first task to be executed corresponding to the at least one first prompt text comprises:
determining, by using a large model, the at least one first prompt text and the at least one first task to be executed according to the input text; and
wherein the large model is obtained by fine-tuning using a plurality of sample texts and a plurality of predetermined prompt texts, and the first prompt text and the adjustment prompt text are determined from the plurality of predetermined prompt texts by using the large model.

13. The method according to claim 11, wherein the large model is obtained by fine-tuning using a plurality of sample texts and a plurality of predetermined prompt texts, and the first prompt text and the adjustment prompt text are determined from the plurality of predetermined prompt texts by using the large model.

14. The method according to claim 1, wherein the obtaining an initial virtual avatar according to at least one prompt text to be processed comprises:
presenting the initial virtual avatar on a visual interface.

15. The method according to claim 2, wherein the processing the at least one task to be processed to obtain the initial virtual avatar comprises:
presenting an identification text of the task to be processed on a visual interface.

16. An electronic device, comprising:
at least one processor; and
a memory communicatively connected to the at least one processor, wherein the memory stores instructions executable by the at least one processor, and the instructions, when executed by the at least one processor, are configured to cause the at least one processor to at least:
determine, according to an input text, at least one first prompt text and at least one first task to be executed corresponding to the at least one first prompt text, wherein the first task to be executed corresponds to at least one second task to be executed, and the second task to be executed corresponds to a second prompt text; and
obtain an initial virtual avatar according to at least one prompt text to be processed, wherein the prompt text to be processed is obtained by fusing the first prompt text and at least one second prompt text corresponding to the first prompt text.

17. The electronic device according to claim 16, wherein the instructions are further configured to cause the at least one processor to at least:
determine at least one task to be processed according to the at least one prompt text to be processed, wherein the task to be processed corresponds to the first task to be executed and the at least one second task to be executed; and
process the at least one task to be processed to obtain the initial virtual avatar.

18. The electronic device according to claim 17, wherein the instructions are further configured to cause the at least one processor to at least:
determine at least one material to be processed and at least one target attribute information corresponding to the at least one material to be processed according to the at least one prompt text to be processed; and
determine the at least one task to be processed according to the at least one material to be processed and the at least one target attribute information corresponding to the at least one material to be processed.

19. The electronic device according to claim 16, wherein the instructions are further configured to cause the at least one processor to at least:
obtain an adjusted virtual avatar according to an adjustment text and the initial virtual avatar.

20. A non-transitory computer-readable storage medium having computer instructions therein, wherein the computer instructions are configured to cause a computer to at least:
determine, according to an input text, at least one first prompt text and at least one first task to be executed corresponding to the at least one first prompt text, wherein the first task to be executed corresponds to at least one second task to be executed, and the second task to be executed corresponds to a second prompt text; and
obtain an initial virtual avatar according to at least one prompt text to be processed, wherein the prompt text to be processed is obtained by fusing the first prompt text and at least one second prompt text corresponding to the first prompt text.
